(19) United States
(12) Patent Application Publication
(10) Pub. No.: US 2022/0001689 A1
(43) Pub. Date: Jan. 6, 2022

(54) PLATE, METHOD FOR MANUFACTURING SAME, AND ELECTRONIC DEVICE

(71) Applicant: BYD COMPANY LIMITED, Shenzhen (CN)

(72) Inventors: Fuhua LUO, Shenzhen (CN); Yanan LI, Shenzhen (CN); Jihou WANG, Shenzhen (CN)

(21) Appl. No.: 17/290,141

(22) PCT Filed: Oct. 30, 2019
(86) PCT No.: PCT/CN2019/114264

§ 371 Date: Apr. 29, 2021

(30) Foreign Application Priority Data
Oct. 31, 2018 (CN) 201811290456.0

(51) Int. Cl. B44C 5/04; B05D 5/06; B41M 1/30; B44C 1/22; B44F 1/08

(52) U.S. Cl. CPC B44C 5/04; B05D 5/06; B44F 1/08; B44C 1/227; B41M 1/30

(57) ABSTRACT

This application provides a plate, a method for manufacturing same, and an electronic device. The method includes: forming a resin layer on a surface of a matrix, where the matrix is formed from organic matter, and a material forming the resin layer is different from a material forming the matrix; immersing the matrix in a first solution, the first solution containing a dye; and lifting the matrix formed with the resin layer out of the solution, where a height by which the matrix is lifted out of the solution per minute is not greater than 180 mm.

### CROSS-REFERENCE TO RELATED APPLICATIONS

This application claims the priority to and benefit of Chinese Patent Application No. 201811290456.0 filed on Oct. 31, 2018 with the National Intellectual Property Administration, PRC, which is incorporated herein by reference in its entirety.

### FIELD

This application relates to the field of electronic devices. Specifically, this application relates to a plate, a method for manufacturing same, and an electronic device, and more specifically, to a plate with a visual effect of a color gradient and an electronic device.

### BACKGROUND

An existing electronic device has a colorful appearance mainly manifested in the housing of the electronic device. The housing of the existing electronic device is usually made of metal, plastic, or glass. A metal housing may provide the electronic device with a metallic appearance. For a plastic or glass housing, plastic or a glass may be dyed to obtain an appearance of a specific color.

However, at present, it is still necessary to improve a plate, an electronic device, and a method for dyeing a plate, especially a dyeing method aimed to implement a visual effect of a color gradient.

### SUMMARY

In an aspect of this application, this application provides a method for manufacturing a plate. The method includes: forming a resin layer on a surface of a matrix, where the matrix is formed from organic matter, a material forming the resin layer includes at least one of acrylic resin, polyurethane resin, or epoxy resin, and the material forming the resin layer is different from a material forming the matrix; making a surface of a side, formed with the resin layer, of the matrix contact a dye-containing solution, and heating the dye-containing solution; and lifting the matrix formed with the resin layer out of the solution, where a height by which the matrix is lifted out of the solution per minute is not greater than 180 mm. The method has at least one of the following advantages: a plate with a color gradient effect can be obtained. The dye and the plate are firmly bonded, the coloring time is short, and there is no fading visible to the naked eye under a solar radiation test. The method is simple to operate, the color is easy to control, the yield is relatively high, and costs are relatively low.

In another aspect of this application, this application provides a plate. The plate includes: a matrix, formed from organic matter; and a resin layer, formed on a surface of the matrix, a material forming the resin layer includes at least one of acrylic resin, polyurethane resin, or epoxy resin, and the material forming the resin layer being different from a material forming the matrix, where a dye is at least contained in a surface of a side, away from the matrix, of the resin layer, and dye content slightly varies at different positions of the resin layer. Therefore, the plate has at least one of the following advantages: the plate has an appearance effect of a color gradient. The plate can be reliably bonded to the dye, and there is no fading visible to the naked eye under a solar radiation test. The plate has a relatively high yield and low costs.

In another aspect of this application, this application provides an electronic device. According to embodiments of this application, a housing of the electronic device is manufactured by using the foregoing plate. Therefore, the electronic device has all the features and advantages of the foregoing plate. Details are not described herein again. Generally, the electronic device has an appearance of a color gradient and relatively low costs.

### BRIEF DESCRIPTION OF THE DRAWINGS

FIG. 1 is a schematic flowchart of a method for dyeing a plate according to an embodiment of this application; and

FIG. 2 is a schematic structural diagram of a plate according to an embodiment of this application.

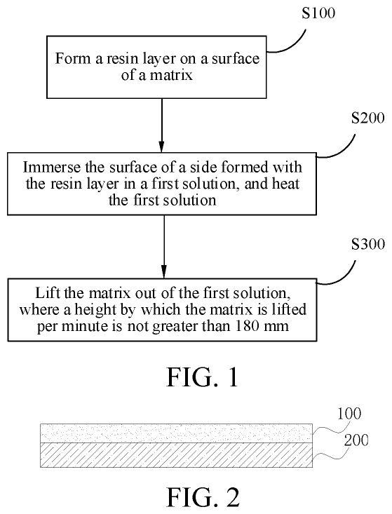

### DETAILED DESCRIPTION

Embodiments of this application are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary and used only for explaining this application, and should not be construed as a limitation on this application.

In an aspect of this application, this application provides a method for manufacturing a plate. Specifically, a plate obtained by using this method may have an appearance effect of a color gradient. According to the embodiments of this application, in the method, a resin layer is first formed on a surface of a matrix, and a side provided with the resin layer is then dyed, so that the resin layer and the dye can be firmly bonded. The coloring time required for the method is short, the obtained plate has no fading visible to the naked eye under a solar radiation test, the color is easy to control, the yield is relatively high, and the costs are relatively low. The dyeing process is controlled, so that the color gradient effect of the surface color of the plate can be easily implemented.

This application is completed based on the following findings of the inventor:

At present, electroplating, direct dyeing, or silk-screening ink methods may be used to render a transparent film with a color effect. The method of electroplating is to use optical physical vapor deposition (OPVD) to perform electroplating on the transparent film. This method requires the design of a complex multilayer film structure, so that a specified color can be obtained through electroplating. Due to the complex film structure, electroplating needs to control the thickness of each layer of the film structure. For example, the thickness is controlled with nanometer level precision. As a result, it difficult to control the color of electroplating, the yield is relatively low, the costs are relatively high. In addition, the electroplating design it is difficult to implement a monochromatic gradient or a multi-color gradient. In a direct dyeing method, it is difficult to completely absorb the dye inside a film, and it is difficult for a material of the film to absorb the dye, leading to the problem of a long coloring time and fading in a solar radiation test. A method of screen-printing ink depends on a screen-printing screen. The color of the screen-printing ink is implemented by opening holes in the screen-printing screen and filling such small holes with ink. Therefore, the same size of the small holes can be implemented when a single-color screen is printed. However, to implement a color gradient, the small holes need to be made with decreasing sizes, so that more ink is discharged from large holes and less ink is discharged from small holes, so as to implement the color gradient effect. However, due to the limitation of a hole-opening process, it is impossible to implement small holes at the micro level, let alone the nano level, or otherwise the screen-printing ink cannot pass the small holes. As a result, it is difficult to implement the color gradient effect or a double-color gradient by controlling the gradient sizes of the small holes in the screen-printing screen.

According to an embodiment of this application, the method includes the following steps:

S100: Form a resin layer on a surface of a matrix.

According to an embodiment of this application, in this step, the resin layer is formed on the surface of the matrix. Specifically, the matrix may be formed from organic matter, a material forming the resin layer includes at least one of acrylic resin, polyurethane resin, or epoxy resin, and the material forming the resin layer is different from a material forming the matrix.

According to an embodiment of this application, the material forming the matrix may include organic polymer materials such as polyethylene terephthalate (PET), polycarbonate (PC), and thermoplastic polyurethane (TPU) elastomer rubber. According to some specific embodiments of this application, the matrix may be transparent. Therefore, the color of the dye can be better manifested. According to an embodiment of this application, a thickness of the matrix may be 0.1 μm to 1 cm.

The method for forming a resin layer is not specifically limited, provided that the resin layer can be formed on the surface of the matrix, and those skilled in the art can make a design according to specific conditions. According to an embodiment of this application, the resin layer may be formed by using a screen-printing, spray coating, printing, or ultraviolet transfer technology. Due to the differences in the properties of materials, compared with a conventional organic material (for example, the foregoing PET or PC), the resin layer has advantages such as that a dye can be adhered more easily, dyeing operations are simple, and pigment color retention after dyeing is adequate. The materials (for example, the foregoing materials) forming the resin layer have a larger gap between molecular chains, and the molecular chains are easier to move especially in a heated state, so that dye molecules can be better embedded inside the molecular chains of the resin layer. According to some exemplary embodiments of this application, the resin layer may be transparent. In this case, the resin layer may have better permeability before dyeing. Therefore, the color of the resin layer is relatively light, and the color of the dye can be better manifested. Moreover, dyeing is performed on the surface of the resin layer with a relatively high transmittance (for example, greater than 85%) is further conducive to obtaining a dyeing effect with a more transparent overall visual effect. When the dyed resin layer has a particular transmittance, the dyed plate as a whole may also have a particular transmittance, so that the appearance film of a lower layer can be observed by the user through the resin layer, thereby further enhancing the visual effect of the plate. The transmittance after dyeing may be controlled by adjusting parameters of subsequent dyeing steps (an immersion time, a lifting time, and the like), and the transmittance after dyeing may be adjusted according to a specific requirement. Therefore, a simple method may be used to form a resin layer on the surface of the plate, to facilitate dyeing on the resin layer in subsequent steps, so that the dye is more firmly bonded to the resin layer, the coloring time is shortened, and the dyed plate has no fading visible to the naked eye under a solar radiation test.

According to an embodiment of this application, as described above, the resin layer may be transparent, and the material forming the resin layer may include at least one of acrylic resin, phenolic resin, or epoxy resin. Therefore, the resin layer has high transparency, to facilitate formation of bright colors on the resin layer in subsequent steps.

According to an embodiment of this application, a thickness of the resin layer may be 5 μm to 100 μm. The thickness of the resin layer is set within the foregoing range to facilitate dyeing of the resin layer in subsequent steps, and also avoids a significant increase in the production costs of forming the resin layer because the thickness of the resin layer is excessively thin. Moreover, the resin layer having the foregoing thickness does not significantly increase the thickness of the plate, and can further prevent the resin layer from being excessively thick, to resolve the problem that the resin layer is likely to fall off the surface of the plate. Furthermore, when a housing of an electronic device is made by the plate manufactured by using the method according to an embodiment of this application, the housing may have the appearance of a color gradient and an appropriate thickness.

According to an embodiment of this application, at least a part of the surface of the resin layer may have a texture pattern. The texture pattern matches a subsequently formed color to further enhance the appearance of the obtained plate. In addition, when the resin layer is provided with a texture pattern, the amount of the dye attached to the resin layer may be increased, so that the resin layer can be better colored in subsequent steps, to further shorten the dyeing time and improve the production efficiency. Moreover, texture structures with different patterns may be arranged at different positions of the resin layer to further improve a gradient effect of the obtained plate. For example, a texture pattern with relatively low roughness may be provided in a region where a relatively light color needs to be formed. For example, line distribution of the pattern may be relatively sparse, or a protrusion height of the pattern may be relatively small. A texture pattern with relatively high roughness may match a region where a relatively dark color needs to be formed. For example, the line distribution of the pattern may be relatively dense, or the protrusion height of the pattern may be relatively large. Therefore, it is convenient to form a color gradient with an adequate visual effect through simple dyeing in subsequent steps. According to some specific embodiments of this application, the foregoing texture pattern may be composed of a plurality of etched lines. A depth of the etched line (or referred to as a thickness of the texture pattern layer) may be 10 μm to 20 μm, and a distance between two adjacent etched lines may be 4 μm to 100 μm. Therefore, appropriate surface roughness may be provided for subsequent dyeing, and the pattern layer with the foregoing size also has an optical effect of glare, and may be superimposed with a color gradient obtained by subsequent dyeing, so that the appearance of the color gradient is more three-dimensional and transparent, and the appearance effect of the plate obtained by using this method can be further improved.

According to an embodiment of this application, before the resin layer is formed on the surface of the matrix, the surface of the matrix may be rinsed to remove oil or impurities on the surface of the matrix, so as to ensure the cleanliness of the surface of the matrix, so that the matrix and the subsequently formed resin layer have an adequate bonding force. According to an embodiment of this application, in the rinsing process, a degreasing agent, a rust remover, and water may be used to clean the surface of the matrix. After the matrix is cleaned, the matrix is dried for later use.

S200: Immerse the surface of a side, formed with the resin layer, of the matrix in a first solution, and heat the first solution.

According to an embodiment of this application, in this step, the surface of the side, formed with the resin layer, of the matrix is immersed in the first solution, and the first solution is heated. According to an embodiment of this application, the first solution containing a dye is first prepared, and the first solution is heated, where a heating temperature may be 80° C. to 100° C. For example, the heating temperature may be 88° C. to 98° C. In a process of heating the first solution to immerse the matrix in the solution and lifting the matrix out of the solution, a temperature of the first solution is 80° C. to 100° C. The inventor finds that when the heating temperature is less than the foregoing temperature range, it is difficult for the dye to be effectively adhered to the surface of the resin layer, resulting in difficulty in coloring. When the heating temperature is greater than the foregoing temperature, the matrix is prone to deformation. Therefore, the heating temperature is set within the foregoing range, to facilitate the attachment of dye molecules, so that the matrix can obtain the color of the dye. According to an embodiment of this application, a temperature of a dye solution may be 85° C., 88° C., 92° C., or 98° C.

The color of the dye is not particularly limited, and those skilled in the art can make a selection according to the color effect obtained in actual requirements. For example, according to an embodiment of this application, the color of the dye may be red, orange, yellow, green, cyan, blue, purple, black, or the like, or a mixed color of two or more of the foregoing colors. According to an embodiment of this application, the dye may include at least one of an azo dye, an anthraquinone dye, or a heterocyclic dye. Therefore, the foregoing dyes may be used for dyeing to obtain a desired color. According to an embodiment of this application, when the first solution is a solution of dyes of two colors, a dispersant and a leveling agent may be added to the first solution. Therefore, a uniform color can be obtained.

According to an embodiment of this application, the surface of the side, formed with the resin layer, of the matrix is then immersed in the first solution for dyeing. According to an embodiment of this application, the time for the matrix to be immersed in the first solution may be 10 seconds to 80 seconds. That is, the matrix is lifted out of the first solution after the matrix is immersed in the first solution for a predetermined time, and the predetermined time may be 10 seconds to 80 seconds. For example, the time may be 20 seconds to 65 seconds, and more specifically, 30 seconds to 65 seconds. In this case, the resin layer on the surface of the matrix may have the color of the dye, and those skilled in the art may adjust, according to an actual requirement of a desired color shade, the length of time of immersing the matrix in the first solution. For example, if an eventually obtained plate needs to have a relatively light color, the matrix may be immersed for a relatively short time. Similarly, if an eventually obtained plate needs to have a relatively dark color, the matrix may be immersed for a relatively long time. According to a specific embodiment of this application, the time for the matrix to be immersed in the first solution may be 15 seconds, 25 seconds, 30 seconds, 45 seconds, 55 seconds, 65 seconds, or 75 seconds.

According to an embodiment of this application, when the matrix is immersed in the first solution, the matrix may be slowly immersed in the heated first solution at a uniform speed. For example, according to some examples of this application, the matrix may be immersed in the first solution for a relatively short time. Specifically, the matrix may be immersed in the first solution at a speed of 100 mm/min to 150 mm/min. Heating the first solution may promote the movement of solute molecules in the first solution, to ensure that the dye molecules in the first solution are more evenly distributed in the solution, thereby improving the dyeing effect and preventing an eventually formed color of the housing from being mottled due to uneven distribution of the dye in the solution.

S300: Lift the matrix formed with the resin layer out of the first solution, where a height by which the matrix is lifted out of the first solution per minute is not greater than 180 mm.

According to an embodiment of this application, in this step, the matrix is slowly lifted out of the first solution, so that different positions of the resin layer on the matrix are immersed in the first solution for different time lengths, so as to obtain a visual effect of a color gradient: a part that is first lifted out of the first solution has a relatively light color due to a relatively short immersion time, whereas a part that is lifted out of the first solution last has a relatively dark color due to a relatively long immersion time.

According to the embodiments of this application, the matrix is not particularly limited to a specific shape, and when the matrix is lifted out of the foregoing solution, a direction in which the matrix is lifted is not particularly limited. For example, according to an embodiment of this application, a height by which the matrix is lifted out of the first solution per minute may not be greater than 180 mm. In this application, “a height by which the matrix is lifted out of the first solution per minute” is specifically a height of the part, lifted out of the solution, of the matrix per minute in a direction perpendicular to the horizontal plane of the dye solution. That is, a rectangular plate is used as an example. The matrix may be lifted out of the dye solution in a long side direction of the plate (matrix), or the plate may be lifted in a width direction of the plate. If the plate has an irregular polygonal shape, a circle shape, an elliptical shape, or the like, the appearance surface (the surface provided with the resin layer) of the matrix may be gradually lifted out of the solution at a particular angle (the appearance surface may be perpendicular to the liquid surface of the solution, or has an acute or obtuse angle with the liquid surface of the solution).

According to an embodiment of this application, as the matrix is lifted out of the first solution, the speed of the lifting is controlled, that is, the immersion time of each region of the matrix in the dye solution is controlled, so that the resin layer with different colors can be obtained, namely, a plate with the color gradient effect can be obtained. As mentioned above, when the matrix is immersed in the first solution for a longer time, a darker color is obtained. When the matrix is lifted out of the first solution at a particular lifting speed of lifting, the region lifted first is immersed in the first solution for the shortest time, so that the color shade obtained in this region is the lightest, and the region lifted last is immersed in the first solution for the longest time, so that the color shade obtained in this region is the darkest. Therefore, a matrix with the color gradient effect is obtained.

According to an embodiment of this application, the matrix may be lifted out of the first solution at a uniform speed. The lifting speed of the lifting may not be greater than 180 mm/min. The inventor finds that when the lifting speed is greater than the foregoing range, it is difficult to obtain the color gradient effect because the lifting speed is excessively fast. Therefore, the lifting speed is set within the foregoing range, so that a plate with an adequate color gradient effect can be obtained. According to a specific embodiment of this application, the lifting speed may be 4 mm/min to 35 mm/min, and may be specifically, 20 mm/min to 35 mm/min. As a result, the color gradient effect of the plate obtained by using the method can be further improved.

According to an embodiment of this application, when the plate is made into a housing of an electronic device, taking a housing of 70 mm×170 mm as an example, the housing may be lifted out of the solution in a long side direction. When the matrix is lifted out of the first solution at a lifting speed of 10 mm/min, it takes about 17 min to form a plate with a color gradient effect. According to some other embodiments of this application, the housing may be lifted out of the first solution in a short side direction of the appearance surface of the housing, or the housing may be lifted out in a diagonal direction of the appearance surface. The time of lifting the entire housing from the solution may be greater than 5 min.

According to some examples of this application, the first solution may be heated to 88° C. to 98° C., the matrix is then immersed in the first solution for 30 seconds to 65 seconds, and the matrix is then lifted out of the first solution at a speed of 20 mm/min to 35 mm/min. The temperature of the first solution is maintained at 88° C. to 98° C. in the process of immersing and lifting the matrix. As a result, an adequate color gradient effect can be obtained.

According to an embodiment of this application, after the matrix is lifted out of the first solution, the dyed matrix needs to be washed and dried sequentially. Specifically, the dyed matrix may be cleaned sequentially through three washing tanks, and each washing tank has built-in ultrasound to clean the solution on the surface of the matrix. Subsequently, the matrix is placed in a baking box for baking, and a baking temperature may be 50° C. to 150° C. until the matrix is dried. After the matrix is dried, the matrix is cooled by natural air. A protective film may be provided on the dyed side of the matrix to prevent the external environment from polluting the surface of the matrix.

According to an embodiment of this application, to further improve the appearance effect of the plate obtained by using the method, the matrix dyed with the first solution may further be immersed in a second solution to continue dyeing. The second solution contains a dye of a color the same as or different from the color of the dye in the first solution. The process of dyeing the matrix with the second solution may be similar to the foregoing dyeing process. For example, the second solution may be heated, and the matrix may then be lifted out of the second solution. The lifting speed of the lifting may be controlled to be the same as the foregoing speed of lifting the matrix out of the first solution. In this case, the appearance of two or more colors with the color gradient effect can be formed. Alternatively, the matrix may be quickly lifted out of the second solution. In this case, the second solution does not form the color gradient effect on the resin layer of the matrix, but implements a superimposition effect of the gradient effect obtained above and the color of the second solution.

According to an embodiment of this application, the color of the dye contained in the second solution may be different from the color of the dye in the first solution. In this case, a plate with a double-color or multi-color gradient effect can be obtained. When the color of the dye contained in the second solution is the same as that of the dye in the first solution, speeds of lifting may be different or directions of lifting may be different (for example, in the long side direction and in the short side direction), so as to obtain a superimposition dyeing effect of the same color.

According to an embodiment of this application, after the dyed matrix is dried, the method may further include: forming a dielectric film layer on the matrix. The dielectric film layer may be located on a side, provided with no resin layer, of the matrix, and specifically, may be superimposed on the side, away from the matrix, of the resin layer. Specifically, the surface of the matrix needs to be dried after being dyed. In this case, a protective film may be provided on the surface of the matrix by using methods including, but not limited to, film coating, such as a PE, PET, or PC film, so as to protect the matrix from pollution before a next process. Before the dielectric film layer is formed, the protective film on the surface of the matrix may be removed first, and the dielectric film layer is then formed on the dyed resin layer by using OPVD. In this case, the dielectric film layer may be formed on the surface of the matrix. According to an embodiment of this application, the dielectric film layer may be a metal film or an oxide film, and the metal film may be metal such as gold, silver, copper, aluminum, indium, or tin, and an alloy such as an indium tin alloy or a silver aluminum alloy. The oxide film may be an oxide such as titanium oxide, titanium sesquioxide, trititanium pentoxide, aluminum oxide, silicon oxide, or niobium oxide. Therefore, the dyed matrix can be protected and the appearance of the plate can be enhanced.

According to an embodiment of this application, a thickness of the dielectric film layer may be 5 nm to 300 nm. The dielectric film layer may include one or more optical film sublayers to protect the dyed surface of the resin layer and implement functions of optical antireflection.

According to an embodiment of this application, the method may further include: performing printing and dyeing a plurality of times on the matrix. As mentioned above, the matrix and the resin layer according to the embodiments of this application may both be transparent. In this case, the dyed matrix still has a particular degree of transparency after dyeing. In this case, the printing and dyeing, specifically, a plurality of times of white printing or a plurality of times of black printing, may be performed to make the plate become opaque, so that the color of dyeing can be better manifested. Alternatively, a plurality of times of white printing and a plurality of times of black printing may be performed. The quantity of times of black printing, the quantity of times of white printing, and the printing and dyeing methods are not specifically limited, and those skilled in the art can make selections according to actual conditions. For example, the foregoing black printing and white printing may be performed on the dielectric film layer. According to some embodiments of this application, it is possible to perform only black printing or only white printing. Alternatively, it is possible to perform both black printing and white printing. The black printing and white printing may be used to screen-print the matrix with an ink of a specific color (black or white). Specifically, the matrix may be screen-printed with white ink three times and black ink twice.

According to an embodiment of this application, a solar radiation test is performed on the plate manufactured according to this method. Specifically, the foregoing plate is placed in a solar radiation box, an ultraviolet lamp is turned on, and continuous irradiation lasts for 96 hours. After the irradiation, the plate is taken out for restoration at room temperature for half an hour before inspection. It is observed that the color of the plate remains unchanged, that is, the plate manufactured according to the method of the embodiments of this application does not show fading visible to the naked eye under the solar radiation test, and has an adequate dyeing effect.

It should be particularly noted that the plate manufactured according to this method may be used alone or in combination with other matrices. For example, when the matrix of the manufactured plate is PET, the plate may be used in combination with a glass matrix. For example, the plate manufactured according to this method may be stacked above or below the glass matrix.

In another aspect of this application, this application provides a plate. According to an embodiment of this application, the plate may be manufactured by using the method described above, and therefore, the plate may have the same features and advantages as the plate manufactured by using the method described above. Details are not described herein again.

According to an embodiment of this application, referring to FIG. 2, the plate includes: a matrix 100 and a resin layer 200. The resin layer 200 is formed on a surface of the matrix 100. At least a part of a surface of a side, away from the matrix 100, of the resin layer 200 is dyed with a dye, and dye content slightly varies at different positions of the resin layer. Specifically, the plate is manufactured by the foregoing method, and the speed at which the matrix is lifted out of the dye-containing solution (the foregoing first solution and second solution) is controlled, so that different positions of the matrix are in contact with the dye-containing solution for different time lengths, to produce the color gradient effect. That is, the part of the matrix lifted out of the dye-containing solution earlier contains a relatively small amount of dye, and the part of the matrix lifted out of the solution last contains a relatively large amount of dye. Dye content at different positions of the resin layer may be controlled by controlling the speed at which the matrix is lifted, which may be determined according to a specific appearance of a to-be-formed color gradient. Specifically, the dye content in the resin layer gradually decreases in a first direction. For example, the matrix is a matrix in the shape of a rectangle. The first direction may be a long side direction or a short side direction of the rectangle. In the first direction, the dye content per square centimeter in the resin layer may decrease from 1 wt % to 0 wt %. According to some examples of this application, in a second direction perpendicular to the first direction, the dye content may not vary at different positions in the resin layer. That is, the color of the resin layer of the plate may gradually change in a single direction. For example, the dye content at different positions of the resin layer in the first direction may gradually increase or decrease, and the dye content at different positions of the resin layer in the second direction may remain unchanged. It should be noted that the descriptions such as “content remains unchanged” and “content does not vary” in this application specifically mean that in a specific direction, the dye content substantially does not vary at different positions in the resin layer, and a difference in color is invisible to the naked eye, rather than that the dye content is strictly equal in value. For example, specifically, from the darkest part of the matrix to the lightest part of the matrix, the dye content may decrease from 1 wt % (per square centimeter) to 0 wt % (per square centimeter).

The material of the resin layer includes at least one of acrylic resin, polyurethane resin, or epoxy resin, and the material forming the resin layer is different from the material forming the matrix. Therefore, the plate has at least one of the following advantages: the plate has an appearance effect of a color gradient. The plate is reliably bonded to the dye, and there is no fading visible to the naked eye under a solar radiation test. The plate has a relatively high yield and low costs.

Detailed descriptions of the material and thickness of the matrix have already been made above. Details are not described herein again. For example, according to an embodiment of this application, the material forming the matrix may include PET, PC, TPU, or the like, and the thickness of the matrix may be 0.1 μm to 1 cm. Therefore, the color gradient effect may be formed on a plurality of materials, and have a wide range of applications.

Detailed descriptions of the material and thickness of the resin layer have already been made above. Details are not described herein again. For example, according to an embodiment of this application, the resin layer may be transparent, the material forming the resin layer may include at least one of acrylic resin, polyurethane resin, or epoxy resin, and the thickness of the resin layer may be 5 μm to 100 μm. Therefore, the dye may enter between polymer chains of the resin layer in the dyeing process, thereby implement more reliable bonding, so that the plate has no fading visible to the naked eye under a solar radiation test.

According to an embodiment of this application, at least a part of the surface of the resin layer may have a texture pattern. Therefore, the texture pattern matches the color formed thereon to further enhance the appearance of the plate. According to an embodiment of this application, the surface of the side, with the dye, of the resin layer may have a texture pattern. Specifically, the texture pattern may include a plurality of etched lines, a depth of the etched line may be 10 μm to 20 μm, and a distance between two adjacent etched lines may be 4 μm to 100 μm.

The color and material of the dye have been described in detail above. Details are not described herein again. For example, according to an embodiment of this application, the color of the dye may be red, orange, yellow, green, cyan, blue, purple, black, or the like, or a mixed color of two or more of the foregoing colors. The dye may include at least one of an azo dye, an anthraquinone dye, or a heterocyclic dye. Therefore, the foregoing dyes may be used to dye the plate to obtain a desired color.

According to an embodiment of this application, the plate may further include a glass substrate. Specifically, the foregoing plate may be stacked above or below the glass substrate.

In another aspect of this application, this application provides an electronic device. According to an embodiment of this application, a housing of the electronic device includes the foregoing plate. Therefore, the electronic device has all the features and advantages of the plate described above. Details are not described herein again. Generally, the electronic device has an appearance of a color gradient and relatively low costs.

The solutions of the present application are described below with reference to embodiments. Those skilled in the art may understand that the following embodiments are only used for describing this application and should not be construed as a limitation to the scope of this application. Specific technologies or conditions that are not noted in the embodiments are performed according to the technologies or conditions described in the documents in this field or according to a product specification. The reagents or instruments for which no manufacturers are noted are all common products commercially available from the market.

### Embodiment 1

The matrix is made of a PET film with a thickness of 0.5 mm. The steps for dyeing the PET film are as follows:

1) Remove oil stains on a surface of the PET film by using a degreasing agent, a rust remover, and water, and then dry the cleaned PET film.

2) Screen-print a textured acrylic resin layer on the surface of the dried PET film by using the screen-printing technology, and a thickness of the acrylic resin layer is 20 μm.

3) Prepare a purple-blue dye solution, add a dispersant and a leveling agent sequentially, and after the solution is uniformly stirred, heat the dye solution to 88° C.

4) Immerse the PET film formed with the acrylic resin layer slowly in the heated dye solution at a uniform speed.

5) Lift the PET film out of the dye solution at a uniform speed of 35 mm/min after the PET film is immersed in the dye solution for 65 seconds.

6) Clean the PET film by passing the film sequentially through three washing tanks after the PET film is lifted, where each washing tank has built-in ultrasound.

7) Place the cleaned PET film in a baking box at a baking temperature of 100° C. until the film is dried.

8) Cool the dried PET film by natural air, and provide a protective film on the surface to protect the dyed film before the next process.

9) Remove the protective film, place the PET film in an evaporation coating machine, produce a vacuum at 3.0×10−3 MPa, start the coating process, and plate a layer of 20-nm thick silicon dioxide on the surface of the PET film.

10) Screen-print the PET film with white ink three times and black ink twice.

The manufactured PET film is placed in a solar radiation box for a solar radiation test, an ultraviolet lamp is turned on, and continuous irradiation lasts for 96 hours. After the irradiation, the PET film is taken out for restoration at room temperature for half an hour before inspection. It is observed that the color of the PET film remains unchanged, that is, the PET film does not show fading visible to the naked eye under the solar radiation test, and has an adequate dyeing effect.

### Embodiment 2

The experiment materials are the same as those in Embodiment 1, the remaining steps of the experiment are the same as those in Embodiment 1, and a difference lies in step 5): Lift the PET film out of the dye solution at a uniform speed of 45 mm/min after the PET film is immersed in the dye solution for 65 seconds. Observation of the dyed plate in Embodiment 2 shows that the color gradient effect of the plate is not obvious, and the color gradient effect of dyeing cannot be fully implemented.

### Embodiment 3

The experiment materials are the same as those in Embodiment 1, the remaining steps of the experiment are the same as those in Embodiment 1, and a difference lies in step 5): Lift the PET film out of the dye solution at a uniform speed of 45 mm/min after the PET film is immersed in the dye solution for 30 seconds. Observation of the dyed plate in Embodiment 3 shows that the plate can be successfully dyed, but the color gradient effect of dyeing is not obvious.

### Embodiment 4

The experiment materials are the same as those in Embodiment 1, the remaining steps of the experiment are the same as those in Embodiment 1, and a difference lies in step 5): Lift the PET film out of the dye solution at a uniform speed of 35 mm/min after the PET film is immersed in the dye solution for 120 seconds. Observation of the dyed plate in Embodiment 4 shows that the plate can be successfully dyed, but the dyed color is slightly dark, and a more obvious color gradient effect cannot be observed.

### Embodiment 5

The experiment materials are the same as those in Embodiment 1, the remaining steps of the experiment are the same as those in Embodiment 1, and a difference lies in step 5): Lift the PET film at a speed of 20 mm/min after the PET film is immersed in the dye solution for 30 seconds. Observation of the dyed plate in Embodiment 5 shows that the plate has a relatively obvious color gradient effect.

### Embodiment 6

The experiment materials are the same as those in Embodiment 1, the remaining steps of the experiment are the same as those in Embodiment 1, and a difference lies in step 5): Lift the PET film out of the dye solution at a uniform speed of 50 mm/min after the PET film is immersed in the dye solution for 65 seconds. Observation of the dyed plate in Embodiment 6 shows that the plate can be dyed, but the color gradient effect of dyeing is not obvious.

### Embodiment 7

The experiment materials are the same as those in Embodiment 1, the remaining steps of the experiment are the same as those in Embodiment 1, and a difference lies in step 3): Heat the dye solution to 98° C., and step 5): Lift the PET film out of the dye solution at a uniform speed of 20 mm/min after the PET film is immersed in the dye solution for 30 seconds. Observation of the dyed plate in Embodiment 7 shows that the plate has a relatively obvious color gradient effect, and the color is darker than that of the plate obtained in Embodiment 5.

### Embodiment 8

The experiment materials are the same as those in Embodiment 1, the remaining steps of the experiment are the same as those in Embodiment 1, and a difference lies in 2): Screen-print a textured polyurethane resin layer on the surface of the dried PET film by using the screen-printing technology, and a thickness of the polyurethane resin layer is 20 μm, and step 5): Lift the PET film out of the dye solution at a uniform speed of 20 mm/min after the PET film is immersed in the dye solution for 30 seconds. Observation of the dyed plate in Embodiment 8 shows that the plate has a relatively obvious color gradient effect.

### Embodiment 9

The experiment materials are the same as those in Embodiment 1, the remaining steps of the experiment are the same as those in Embodiment 1, and a difference lies in 2): Screen-print a textured epoxy resin layer on the surface of the dried PET film by using the screen-printing technology, and a thickness of the epoxy resin layer is 20 μm, and step 5): Lift the PET film out of the dye solution at a uniform speed of 20 mm/min after the PET film is immersed in the dye solution for 30 seconds. Observation of the dyed plate in Embodiment 9 shows that the plate has a relatively obvious color gradient effect.

### Embodiment 10

The experiment materials are the same as those in Embodiment 1, the remaining steps of the experiment are the same as those in Embodiment 1, and a difference lies in 2): a thickness of the formed acrylic resin layer is 50 μm. step 5): Lift the PET film out of the dye solution at a uniform speed of 20 mm/min after the PET film is immersed in the dye solution for 30 seconds. Observation of the dyed plate in Embodiment 10 shows that the plate has a relatively obvious color gradient effect.

### Embodiment 11

The experiment materials are the same as those in Embodiment 1, the remaining steps of the experiment are the same as those in Embodiment 1, and a difference lies in that after step 6), the steps further include: preparing a red dye solution, adding a dispersant and leveling agent sequentially, heating the dye solution to 88° C. after the solution is uniformly stirred, and lifting the PET film out of the red dye solution at a uniform speed of 20 mm/min after the PET film dyed for the first time is dipped into the dye solution from a relatively dark part and immersed for 65 seconds. Observation of the dyed plate in Embodiment 11 shows that the plate has a relatively obvious purple-blue gradient effect.

### COMPARATIVE EXAMPLE 1

The experiment materials are the same as those in Embodiment 1, the remaining steps of the experiment are the same as those in Embodiment 1, and a difference lies in step 2): Heat the dye solution to 60° C. Observation of the dyed plate of Comparative Example 1 shows that it is difficult for the dye to be effectively adhered to the surface of the resin layer, and the color of the plate is excessively light to present an obvious color gradient effect. Therefore, the plate cannot implement an adequate dyeing effect of a color gradient.

In the description of this application, terms “longitudinal”, “latitude”, “upper”, “lower”, “front”, “rear”, “left”, “right”, “vertical”, “horizontal”, and orientation or positional relationship indicated by “top”, “bottom”, and the like is based on orientation or positional relationship shown in the drawings, which is only for the convenience of describing this application rather than requiring that this application to be constructed and operated in a specific orientation, and not to be understood as restrictions on this application.

In the description of this specification, the description with reference to the terms “one embodiment”, “another embodiment”, and the like means that the specific feature, structure, material, or characteristic described in conjunction with the embodiment is included in at least one embodiment of this application. In this specification, schematic descriptions of the foregoing terms are not necessarily directed at the same embodiment or example. Besides, the specific features, the structures, the materials or the characteristics that are described may be combined in proper manners in any one or more embodiments or examples. In addition, a person skilled in the art may integrate or combine different embodiments or examples described in the specification and features of the different embodiments or examples as long as they are not contradictory to each other.

Although the embodiments of this application have been shown and described above, it can be understood that, the foregoing embodiments are exemplary and should not be understood as limitation to this application. A person of ordinary skill in the art can make changes, modifications, replacements, or variations to the foregoing embodiments within the scope of this application.

1. A method for manufacturing a plate, comprising:
forming a resin layer on a surface of a matrix, wherein the matrix is formed from an organic matter, and a material forming the resin layer is different from the organic matter forming the matrix;
immersing the matrix in a first solution, the first solution containing a dye; and
lifting the matrix formed with the resin layer out of the first solution at a speed of not greater than 180 mm per minute.

2. The method according to claim 1, wherein the first solution is heated.

3. The method according to claim 1, wherein the organic matter forming the matrix comprises at least one of polyethylene terephthalate (PET), thermoplastic polyurethane (TPU) elastomer, and polycarbonate (PC).

4. The method according to claim 1, wherein a thickness of the resin layer is 5 μm to 100 μm.

5. The method according to claim 1, wherein at least a part of a surface of the resin layer is provided with a texture pattern;
wherein the dye comprises at least one of an azo dye, an anthraquinone dye, and a heterocyclic dye; and
wherein the first solution further comprises at least one of a dispersant and a leveling agent.

6. The method according to claim 1, wherein the matrix is lifted out of the first solution after the matrix is immersed in the first solution for 10 seconds to 80 seconds.

7. The method according to claim 2, wherein a temperature of the first solution is 80° C. to 100° C.

8. The method according to claim 1, wherein the matrix formed with the resin layer is lifted out of the solution at a speed of 4 mm/min to 35 mm/min.

9. The method according to claim 1, further comprising: immersing the matrix in a second solution, heating the second solution, and lifting the matrix out of the second solution, wherein the second solution contains a dye.

10. The method according to claim 1, further comprising at least one of the following steps:
rinsing the surface of the matrix before the resin layer is formed;
washing and drying the matrix sequentially after the matrix is lifted out of the first solution;
after the matrix is lifted out of the first solution, forming a dielectric film layer on the dyed resin layer, wherein a thickness of the dielectric film layer is greater than 5 nm; and the dielectric film layer comprises one or both of a metal film and an oxide film; and
after the matrix is lifted out of the dye-containing solution, performing printing and dyeing, wherein the printing and dyeing comprise at least one of black printing or a white printing.

11. The method according to claim 1, wherein the material forming the resin layer comprises at least one of acrylic resin, polyurethane resin, and epoxy resin; and the first solution is heated.

12. A plate, comprising:
a matrix, formed from an organic matter; and
a resin layer, formed on a surface of the matrix, a material forming the resin layer being different from the organic matter forming the matrix,
wherein a dye is at least contained in a surface of a side of the resin layer that is away from the matrix, and a dye content of the dye slightly varies at different positions of the resin layer.

13. The plate according to claim 12, wherein the dye content in the resin layer gradually decreases in a first direction.

14. The plate according to claim 13, wherein the matrix is in the shape of a rectangle, and the first direction is a long side direction or a short side direction of the rectangle;
in the first direction, the dye content per square centimeter in the resin layer decreases from 1 wt % to 0 wt %; and
in a second direction perpendicular to the first direction, the dye content does not vary at different positions in the resin layer.

15. The plate according to claim 12, wherein the material organic matter forming the matrix comprises at least one of polyethylene terephthalate (PET), thermoplastic polyurethane (TPU) elastomer, and polycarbonate (PC).

16. The plate according to claim 15, wherein the material forming the resin layer comprises at least one of acrylic resin, polyurethane resin, and epoxy resin.

17. The plate according to claim 12, wherein a thickness of the resin layer is 5 μm to 100 μm.

18. The plate according to claim 12, wherein at least a part of a surface of the resin layer has a texture pattern; and
optionally, the texture pattern comprises a plurality of etched lines, a depth of the etched line is 10 μm to 20 μm, and a distance between two adjacent etched lines is 4 μm to 100 μm.

19. The plate according to claim 12, wherein a side of the resin layer that is away from the matrix further comprises: a dielectric film layer.

20. An electronic device, a housing of the electronic device comprising the plate according to claim 12.
